(19) United States
(12) Patent Application Publication
(10) Pub. No.: US 2019/0145352 A1
(43) Pub. Date: May 16, 2019

(54) FUEL SUPPLY DEVICE WITH INLET VALVE

(71) Applicant: Walbro LLC, Tucson, AZ (US)

(72) Inventors: Tomoya Kawada, Sendai-city (JP); Naoya Kumagai, Iwanuma-City (JP)

(21) Appl. No.: 16/191,499

(22) Filed: Nov. 15, 2018

Related U.S. Application Data
(60) Provisional application No. 62/586,251, filed on Nov. 15, 2017.

(51) Int. Cl. F02M 21/02

(52) U.S. Cl. CPC F02M 21/023

(57) ABSTRACT

In at least some implementations, a fuel supply device includes a body assembly having a main bore from which fuel is supplied, an inlet passage, a valve seat adjacent to the inlet passage and a fuel chamber communicated with the main bore and with the inlet passage to receive a supply of fuel from the inlet passage, and an inlet valve carried by the body assembly. The inlet valve has a valve head with a body and an engagement portion extending outwardly from the body. The inlet valve is movable relative to the valve seat from an open position in which the engagement portion is spaced from the valve seat and fuel from the inlet passage may flow through the valve seat and into the fuel chamber and a closed position in which the engagement portion is engaged with the valve seat.

### REFERENCE TO RELATED APPLICATIONS

This application claims the benefit of U.S. Provisional Application Ser. No. 62/586,251 filed on Nov. 15, 2017, the entire contents of which is incorporated herein by reference in its entirety.

### TECHNICAL FIELD

The present disclosure relates generally to a fuel system component, and more particularly to a fuel supply device that provides gaseous fuel and air to an engine.

### BACKGROUND

Internal combustion engines are capable of running on multiple types of gaseous fuels such as propane, butane and natural gas. Providing a gaseous fuel mixed with air to the engine entails the use of valves, regulators and mixers to control the amount of fuel and pressure at which the fuel is delivered. Valves that open and close reliably, at consistent pressures are needed to supply a desired fuel and air mixture to the engine, in accordance with the engine fuel demand. Inconsistent valve performance leads to inconsistent fuel and air mixtures delivered to the engine and can result in unsatisfactory engine performance.

### SUMMARY

In at least some implementations, a fuel supply device includes a body assembly having a main bore from which fuel is supplied, an inlet passage, a valve seat adjacent to the inlet passage and a fuel chamber communicated with the main bore and with the inlet passage to receive a supply of fuel from the inlet passage, and an inlet valve carried by the body assembly. The inlet valve has a valve head with a body and an engagement portion extending outwardly from the body. The inlet valve is movable relative to the valve seat from an open position in which the engagement portion is spaced from the valve seat and fuel from the inlet passage may flow through the valve seat and into the fuel chamber and a closed position in which the engagement portion is engaged with the valve seat.

In at least some implementations, the engagement portion is an annular lip that surrounds an end of the inlet passage when the inlet valve is in the closed position. The annular lip, when coaxially aligned with the inlet passage, may be radially spaced from an edge of the inlet passage by at least 0.5 mm. The lip may be formed in a face of the valve head that is opposed to the valve seat, and the lip may extend axially to a free end that is spaced from the valve face by between 0.2 mm and 1.2 mm, and the lip may have a radial thickness of between 0.4 mm and 1.5 mm.

The valve seat may be annular and located radially outboard of the inlet passage. The valve seat may be annular and planar, and the engagement portion may extend axially relative to the valve seat and relative to an axis of the valve seat. The valve seat may be defined by an insert that is carried by the body assembly and which includes a bore that defines part of the inlet passage.

The engagement portion may be formed from softer material than the valve seat, and in at least some implementations, the engagement portion is formed from a polymeric material having a hardness between 50 to 80 on the Shore-A scale.

The device may include a diaphragm carried by the body assembly and defining part of the fuel chamber. The diaphragm may have a portion that moves relative to the valve seat and which causes movement of the inlet valve relative to the valve seat. A lever may pivot relative to the valve seat and the valve head may be carried by the lever so that the lever is moved by the diaphragm. The lever may be coupled to a pin between opposite ends of the lever, and the diaphragm may act upon a portion of the lever that is on one side of the pin and the valve head may be carried by the lever on the other side of the pin. The valve head may include a knob that is received in an opening of the lever so that the valve head may tilt and/or slide relative to the lever.

In at least some implementations, a fuel supply device includes a main body, a cover coupled to the main body, a diaphragm trapped between the main body and cover, and an inlet valve. The main body has a main bore from which fuel is supplied, an inlet passage, a valve seat adjacent to the inlet passage and a fuel chamber communicated with the main bore and with the inlet passage to receive a supply of fuel from the inlet passage. The inlet valve has a valve head with a body and an engagement portion extending outwardly from the body. A portion of the diaphragm moves relative to the valve seat to move the inlet valve relative to the valve seat from an open position in which the engagement portion is spaced from the valve seat and a closed position in which the engagement portion is engaged with the valve seat.

In at least some implementations, the engagement portion is defined by an annular lip that is formed in a face of the valve head that is opposed to the valve seat, and the lip extends axially to a free end that is spaced from the valve face by between 0.2 mm and 1.2 mm, and the lip has a radial thickness of between 0.4 mm and 1.5 mm. The engagement portion may be defined by an annular lip that, when coaxially aligned with the inlet passage, is radially spaced from an edge of the inlet passage by at least 0.5 mm.

In at least some implementations, the lever is coupled to a pin between opposite ends of the lever, and the diaphragm acts upon a portion of the lever that is on one side of the pin and the valve head is carried by the lever on the other side of the pin. The valve head may include a knob that is received in an opening of the lever so that the valve head may tilt and/or slide relative to the lever.

### BRIEF DESCRIPTION OF THE DRAWINGS

The following detailed description of certain embodiments and best mode will be set forth with reference to the accompanying drawings, in which:

FIG. 1 is a perspective view of a fuel supply device;

FIG. 2 is a front view showing the inlet side of the fuel supply device

FIG. 3 is a side view of the fuel supply device;

FIG. 4 is a rear view showing the outlet side of the fuel supply device;

FIG. 5 is a cross-sectional view of the fuel supply device;

FIG. 6 is an enlarged, fragmentary sectional view illustrating an inlet valve of a metering assembly;

FIG. 7 is a graph of opening pressure vs. valve seat height for two inlet valve constructions at different alignment positions; and

FIG. 8 is a graph of closing pressure vs. valve seat height for two inlet valve constructions at different alignment positions.

### DETAILED DESCRIPTION

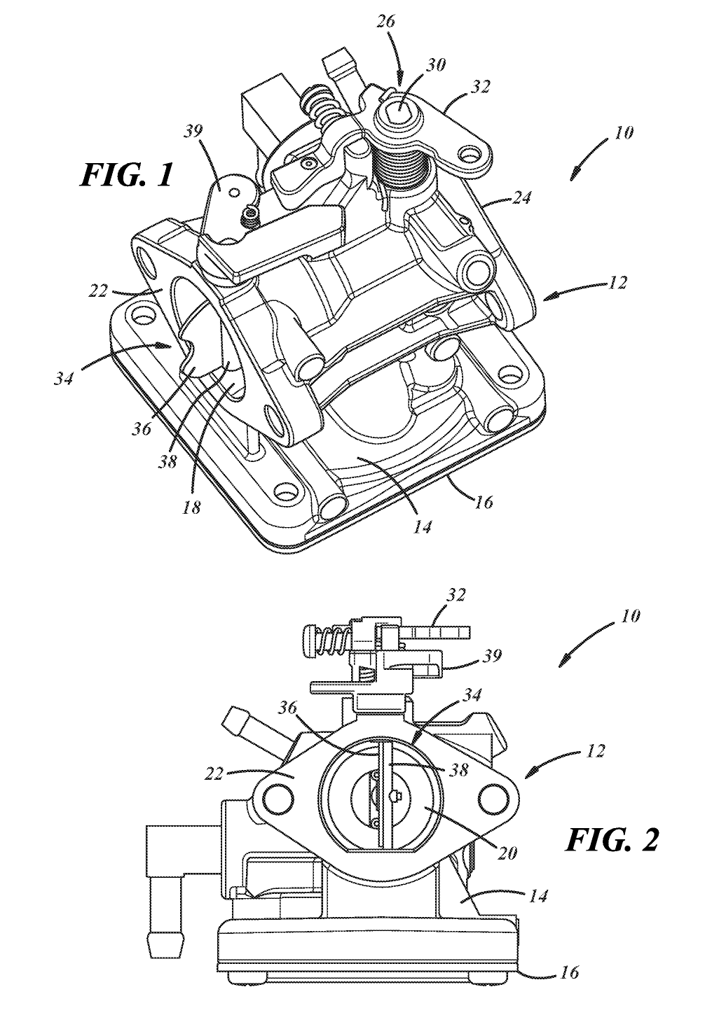

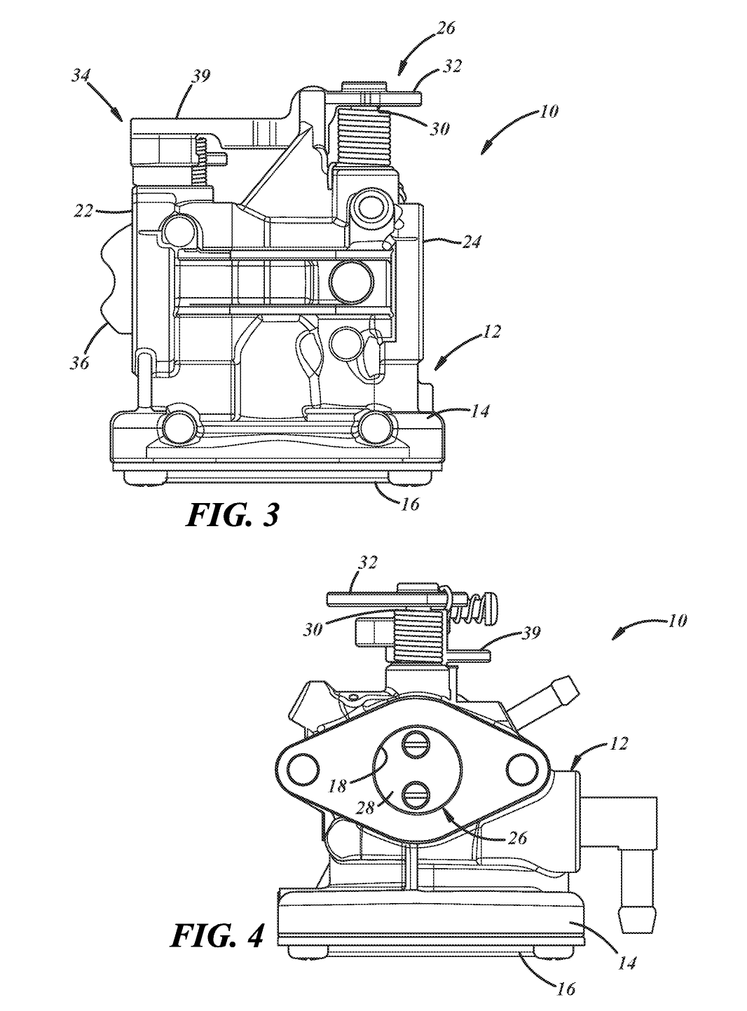

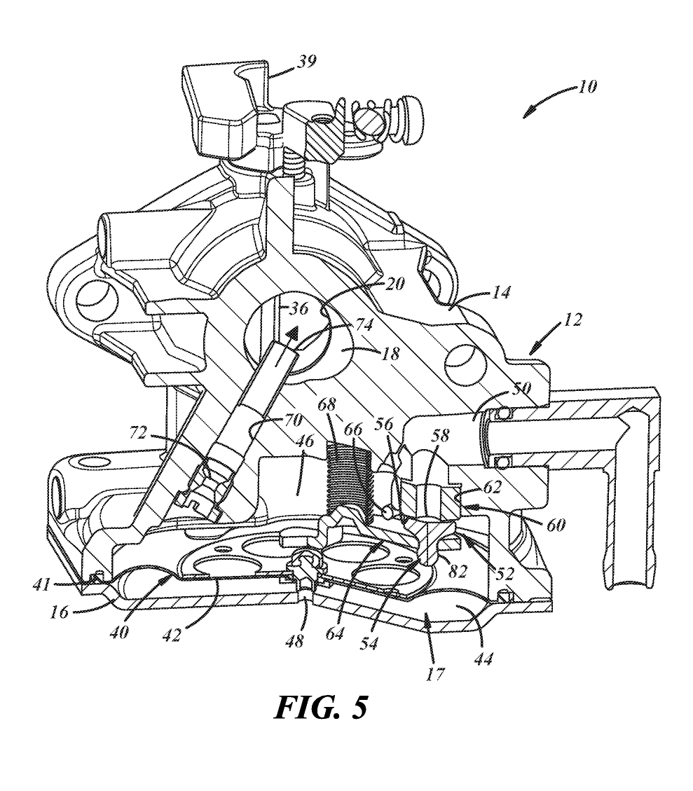

Referring in more detail to the drawings, FIGS. 1-5 illustrate a fuel supply device 10 that mixes air and gaseous fuel and supplies a fuel and air mixture to an engine to support operation of the engine. The device 10 includes a body assembly 12 having a main body 14 and a cover 16 for a gas metering assembly 17 (FIG. 5) coupled to the main body 14. The main body 14 may include a main bore 18 that may include a constriction or reduced diameter section, for example a venturi 20 (FIGS. 2 and 5), between inlet and outlet sides 22, 24, respectively, to help create a pressure drop across the main bore 18 and improve air and gas flow therein and therethrough. A throttle valve 26 may be provided downstream of the venturi 20 and is movable to control the fuel flow in and through the main bore 18. The throttle valve 26 may include a butterfly-type valve head 28 (FIG. 4) fixed to a rotatable shaft 30 that can be rotated by a cable coupled to a lever 32 fixed to the throttle valve 26, in known manner. The throttle valve 26 may be rotated between a first position associated with engine idle operation and a second position associated with engine wide open throttle operation. Less air and fuel flow through the main bore 18 when the throttle valve 26 is in the first position than in the second position. The device 10 may also include a choke valve 34 that may include a choke valve head 36 coupled to a choke valve shaft 38 rotatably carried by the main body 14. The choke valve 34 may be rotated between a first position and a second position by actuation of a choke valve lever 39. Less air and fuel flow through the main bore 18 when the choke valve 34 is in the first position than in the second position. The choke valve 34 may be rotated to its first position to facilitate starting a cold engine, and may be rotated to its second position during normal operation of the engine, as is known in the art. The choke valve 34 may be provided near the inlet side 22 of the main bore 18 and the throttle valve 26 may be closer to the outlet side 24 of the main bore 18.

As shown in FIG. 5, the metering assembly 17 may include a diaphragm 40 that is trapped about its periphery 41 between the main body 14 and the cover 16. An untrapped central portion 42 of the diaphragm 40 defines a reference chamber 44 with the cover 16 and a fuel chamber 46 with the main body 14. The untrapped central portion 42 of the diaphragm 40 is moved due to a pressure differential across it caused by varying pressure in one or both of the reference and fuel chambers 44, 46. The reference chamber 44 may be communicated with the atmosphere through a vent 48, or the reference chamber 44 can be communicated with a different pressure source, such as an intake manifold of the engine via a suitable passage. The fuel chamber 46 is communicated with a supply of fuel and with the main bore 18 through which the pressurized fuel is mixed with air in the main bore 18.

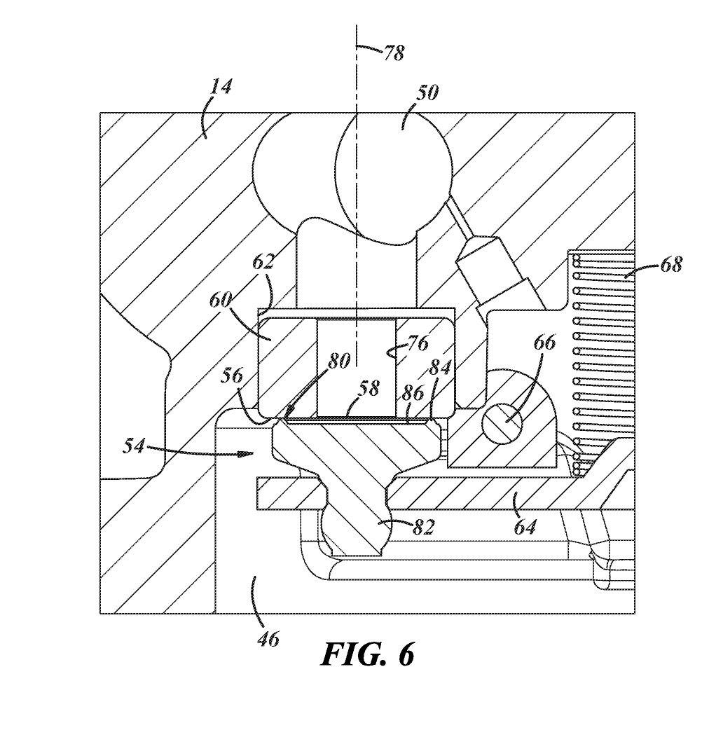

Pressurized fuel is communicated with the fuel chamber 46 via an inlet passage 50 formed at least partially within the main body 14. An inlet valve 52 may be carried by the body assembly 12 (e.g. by main body 14) and may control the admission of fuel into the fuel chamber 46 in accordance with a pressure of fuel in the fuel chamber 46. The inlet valve 52 may include a valve head 54 movable relative to a valve seat 56. The valve seat 56 may be annular and surround an outlet 58 of the inlet passage 50. The valve seat 56 may be defined in or by a surface of the main body 14 or by an insert 60 carried by the main body 14 (e.g. an annular insert pressed into a cavity 62 of the main body 14 as shown in FIGS. 5 and 6). The valve head 54 may be carried by a lever 64 pivoted between its ends about a pin 66 coupled to the main body 14. The lever 64 may be acted upon by the diaphragm 40 on one side of the pivot pin 66 and the valve head 54 may be carried by the lever 64 on the other side of the pivot pin 66. A biasing member, such as a coil spring 68, may act on the lever 64 to yieldably bias the inlet valve 52 in a desired direction (e.g. either toward its open or closed positions). In the example shown, the spring 68 biases the inlet valve 52 toward its closed position. That is, the spring 68 provides a force on the lever 64 that tends to rotate the lever 64 in a direction that engages the valve head 54 against the valve seat 56 to inhibit or prevent fuel flow through the inlet valve 52 unless and until the diaphragm 40 engages the lever 64 and opens the valve, as will be set forth in more detail below.

Fuel in the fuel chamber 46 is fed to the main bore 18 via a main fuel passage 70. A fuel jet 72 or other restriction maybe provided within the main fuel passage 70 to control the flow rate of fuel that flows therethrough. The fuel jet 72 or restriction may be integrally formed in the main body 14 (e.g. by a smaller diameter section of the fuel passage) or it may be defined in an insert that is fixed in the main fuel passage 70. The main fuel passage 70 is open at an outlet 74 to the interior of the main bore 18 and may be defined at least in part by a passage formed in the main body 14. The outlet 74 of the main fuel passage 70 may be located anywhere within the main bore 18 between the inlet and outlet sides 22, 24 that provides a desired pressure signal at the outlet to provide a desired fuel flow into the air stream flowing through the main bore 18.

In operation, fuel from a fuel supply (such as a fuel tank) is provided into the fuel chamber 46 via the inlet passage 50 and the inlet valve 52 when the inlet valve 52 is open. Fuel flows from the fuel chamber 46 through the fuel jet 72 and into the main bore 18 whereupon the fuel is mixed with air flowing through the main bore 18. The fuel and air mixture exits the device 10 through the outlet side 24 of the main bore 18 and is delivered to the engine. A subatmospheric pressure may exist within the main bore 18 due to the air flow through the venturi section 20 of the main bore 18, and because of a negative pressure provided from the engine to the main bore 18. That subatmospheric pressure is communicated with the fuel chamber 46 via the fuel passage and acts on the diaphragm 40. Further, the atmospheric pressure in the reference chamber 44 also acts on the diaphragm 40. As fuel is discharged from the fuel chamber 46, the pressure in the fuel chamber 46 decreases. The combination of these factors moves the diaphragm 40 away from the cover 16 and reduces the volume of the pressure chamber. This also causes the diaphragm 40 to engage and displace the lever 64 to open the inlet valve 52 and admit more fuel into the fuel chamber 46. This must be done against the force of the spring 68 acting on the lever 64 which provides a further force on the diaphragm 40, in addition to the pressures noted above, and thus affects the opening and closing of the inlet valve 52. The inlet valve 52 remains open until the diaphragm 40 is displaced sufficiently to permit the spring to close the inlet valve 52. The inlet valve 52 may move between its open and closed positions as the pressure within the fuel chamber 46 varies due to fuel consumption by the engine and fuel admission into the fuel chamber 46 as noted above. Upstream of the inlet valve 52, a shutoff valve may be provided to securely close off the fuel flow to the device when the engine is not in use.

As shown in FIG. 6, the valve seat 56 may be a flat, planar area or surface outboard of or at the outer edge of the inlet passage 50. In the example shown, the valve seat 56 is defined by a metal insert 60 carried in a counterbore 62 that is coaxial with the inlet fuel passage 50. The insert 60 is annular and includes a bore 76 that defines part of the inlet passage 50 including the outlet 58, and through which all fuel flows before entering the fuel chamber 46. The valve seat 56 is planar and at a right angle to the axis 78 of the inlet passage 50 just upstream of the valve seat 56.

The valve head 54 may include a body and an engagement portion 80 that extends outwardly from the body and is adapted to abut the valve seat 56 in the closed position of the inlet valve 52 to substantially inhibit or prevent fuel flow through the valve seat 56. The valve head 54 may be movably carried by the lever 64 so that the valve head 54 may move relative to the lever 64 to facilitate a generally planar and circumferentially continuous engagement between the engagement portion 80 and the valve seat 56. In the implementations shown, the valve head 54 includes a knob 82 that is opposite to the engagement portion 80 and is pressed into an opening in the lever 64. So arranged, the valve head 54 may tilt and/or slide relative to the lever 64 to align the valve head 54 with the valve seat 56.

The valve head 54 may be formed from a resilient and somewhat flexible material that may engage the valve seat 56 over a limited surface area that is less than the extent of overlap between the valve head 54 and the valve seat 56. In the example shown, the overlap is in a radial direction relative to an axis of the valve seat 56. In at least some examples, the engagement portion 80 is defined by an axially extending and circumferentially continuous rim or lip 84 formed in a face 86 of the valve head 54 that is opposed to the valve seat 56. The lip 84 may extend axially to a free end that is spaced from the valve face 86 by between 0.2 mm and 1.2 mm, and may have a radial thickness of between 0.4 mm and 1.5 mm. The lip 84 may be circular and coaxial with the passage 76 through the valve seat 56, if desired, or may be of any other shape and orientation. So arranged, in the closed position of the valve head 54 the lip 84 engages the valve seat 56 and the valve face 86 may be spaced from the valve seat 56. This provides an area inboard of the lip 84 and between the valve face 86 and an opposed face of the body defining the valve seat 56, that is open to the inlet passage 50. The engagement portion 80 may be formed integrally with the remainder of the valve head 54, or it could be defined by an insert or from another material that is coupled to the valve head 54 (e.g. by insert or overmolding, connected by a press-fit, fastener, adhesive, weld, etc). The engagement portion 80 may be formed from a material that has a hardness or durometer between 50 and 80 on the Shore-A scale. In at least some implementations, the valve head 54 may be formed from polymeric (e.g. rubber) materials including NBR, H-NBR, and FKM, and the valve seat 56 may be formed from a metal such as brass, stainless steel or aluminum (e.g. an aluminum alloy).

If the valve seat 56 is formed with an axially extending lip that provides a limited surface area of engagement with a planar valve face of the valve head 54, the softer valve head 54 may become deformed or damaged over time by engagement with the harder valve seat 56 material over the limited surface area. That is, an annular groove may be worn into the softer valve head material in the area of engagement with the valve head. The worn, deformed or damaged portion may make sealing unreliable or difficult if the position of the valve shifts relative to the valve seat, e.g. if the inlet valve shifts laterally relative to the pivot pin on which it is mounted (where laterally is along the axis of the pivot pin). Such shifting due to vibrations in use or otherwise, may misalign the damaged or worn portion relative to the valve seat and affect future closing of the inlet valve. Further, if both the valve seat 56 and valve head 54 are formed flat and planar, it may be more difficult to compress the valve head material against the valve seat and the seal might not be satisfactory, or the valve head may tend to stick against the valve head due a force or pressure differential across them.

In the implementations shown, the engagement portion 80 may be provided, in a nominal or centered position, at least 0.5 mm outboard (e.g. radially spaced from or outboard) of the inlet passage 50. The lip, when coaxially aligned with the inlet passage, may be spaced from an edge of the inlet passage by at least 0.5 mm. Stated differently, at least with a circular lip 84, an inner diameter of the lip may be 1 mm or greater than the diameter of the inlet passage 50, 76 at the valve seat 56. With the spacing between the edge of the inlet passage and the engagement portion 80 of the valve head 54, the inlet valve 52 may shift laterally (or the relative locations of the valve head 54 and/or valve seat 56 may change within a production run of these devices 10) while still providing a reliable and consistent sealing or closing of the valve head 54 against the valve seat 56.

FIG. 7 is a graph of pressure vs. location of the valve seat showing the pressure differential across the valve head 54 that is needed to open the valve. In this example, the valve seat 56 has a diameter of 10 mm, a gas flow rate of 0.2 L/minute and the spring on the lever 64 has a nominal force of 70 g in the closed position of the valve. The location of the valve seat (noted as seat position in FIG. 7) is relative to a position of the valve seat (i.e. the insert) wherein the valve seat is parallel to the sealing portion of the valve head. With the valve head being pivoted about a pin, movement of the valve seat away from the nominal or 0.0 mm position will create some angle between the valve head and valve seat as the valve head is swung along an arc about the pivot pin.

The upper three lines 88, 90, 92 in FIG. 7 are pressure profiles for a valve seat 56 including an axially extending valve seat 56 that engages a flat valve head 54 (in other words, not as shown in FIG. 5 or 6). In this arrangement, the opening pressure for the inlet valve varies considerably as the valve seat moves away from the nominal 0.0 mm position. In the example tested and shown in FIG. 7, between a valve seat position of −0.2 mm (which represents the valve seat being lower relative to the valve head (e.g. the insert is not pressed into cavity 62 all the way to the 0.0 mm position) to a valve seat at the 0.0 mm position, the opening pressure may vary between 5.0 kPa and almost 8.0 kPa. Also in this arrangement of a valve seat and valve head, the opening pressure varies considerably as the valve head moves radially or laterally relative to the valve seat, that is, when the valve head remains closed on the valve seat but is misaligned or not perfectly centered relative to the valve seat. The first 88 of these lines shows the pressure profile when the valve head 54 has moved in a first direction relative to a centered position relative to the valve seat 56. The second 90 of these lines shows the pressure profile when the valve head 54 has moved in a second direction relative to the centered position relative to the valve seat 56. The third 92 of these lines shows the pressure profile when the valve head 54 is in the centered position relative to the valve seat 56. Accordingly, the pressure at which the valve head 54 opens varies considerably not only due to the seat position but also due to alignment of the valve head 54 to the valve seat 56. In the 0.0 mm position, the variance between the first and second lines is 1 kPa or more due to misalignment of the valve head 54 with the valve seat 56.

In FIG. 7, the lower three lines 94, 96, 98 are pressure profiles for a planar valve seat 56 and a valve head 54 including an axially extending engagement portion 80 that engages the flat valve seat 56, such as is shown in FIGS. 5 and 6. The opening pressure is more consistent across the various positions of the valve head 54, is more consistent when the valve head 54 is misaligned or not centered relative to the valve seat 56 and may be lower than for the valve arrangement of the upper three lines. In the example shown, the opening pressure varies only between a minimum of about 5.0 kPa to 5.6 kPa between valve seat locations of −0.2 mm and 0.0 mm. This is significantly less variance (0.6 kPa vs. nearly 3.0 kPa) than for the valve seat/valve head embodiment of the upper three lines 88, 90, 92. Further, in the arrangement set forth herein and shown by lines 94, 96 and 98, the opening pressure does not vary significantly as the valve head 54 moves laterally or radially relative to the valve seat 56 (e.g. is not centered or is misaligned). The first 94 of these lines shows the pressure profile when the valve head 54 has moved in a first direction relative to a centered position relative to the valve seat 56. The second 96 of these lines shows the pressure profile when the valve head 54 has moved in a second direction relative to the centered position relative to the valve seat 56. The third 98 of these lines shows the pressure profile when the valve head 54 is in the centered position relative to the valve seat 56. Accordingly, the pressure at which the valve head 54 opens is much more consistent in view of both changes to the seat position and also due to alignment of the valve head 54 to the valve seat 56. In the 0.0 mm position, the variance between the first and second lines is about 0.1 kPa due to misalignment of the valve head 54 with the valve seat 56. This is about 10 times less than in the valve seat/valve head embodiment of the upper three lines.

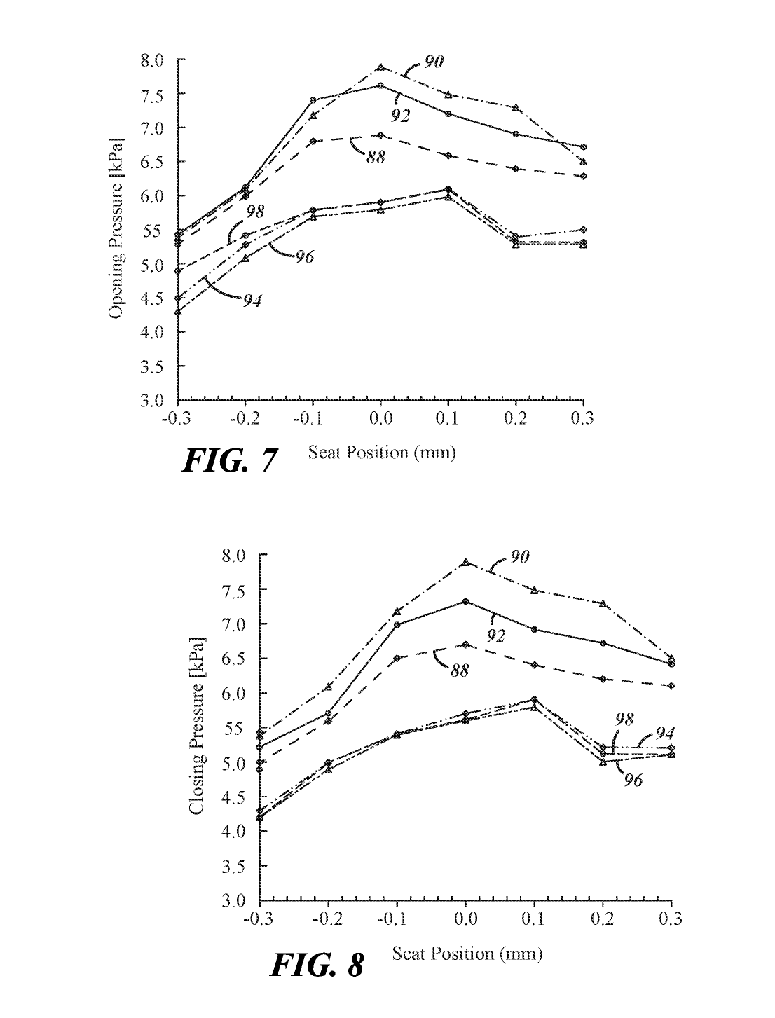

FIG. 8 illustrates the two valve embodiments under similar conditions but shows the pressure needed to close the valve. Again, the upper three lines 88, 90, 92 show considerably more variance due to seat position and due to misalignment of the valve head 54 relative to the valve seat 56 than do the lower three lines 94, 96, 98 which represent a valve head 54 with an engagement portion 80 as set forth herein.

Thus, among other things, the inlet valve head having an outwardly extending engagement portion that defines a limited surface area of engagement with a valve seat may achieve less variation and more consistent inlet valve performance, and less wear or deformation of the inlet valve head. Further, the resilient and flexible material of the inlet valve head may facilitate providing a closed position of the valve head that inhibits or prevents fuel flow therethrough even when misaligned or not centered relative to the inlet passage or valve seat. The inlet valve head may be relatively inexpensive to form and can, if desired, be formed from a single piece of material including an integral mounting feature (e.g. the knob) and an integral engagement portion.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A fuel supply device, comprising:
a body assembly having a main bore from which fuel is supplied, an inlet passage, a valve seat adjacent to the inlet passage and a fuel chamber communicated with the main bore and with the inlet passage to receive a supply of fuel from the inlet passage; and
an inlet valve carried by the body assembly and having a valve head with a body and an engagement portion extending outwardly from the body, wherein the inlet valve is movable relative to the valve seat from an open position in which the engagement portion is spaced from the valve seat and fuel from the inlet passage may flow through the valve seat and into the fuel chamber and a closed position in which the engagement portion is engaged with the valve seat.

2. The device of claim 1 wherein the engagement portion is an annular lip that surrounds an end of the inlet passage when the inlet valve is in the closed position.

3. The device of claim 2 wherein the annular lip, when coaxially aligned with the inlet passage, is radially spaced from an edge of the inlet passage by at least 0.5 mm.

4. The device of claim 1 wherein the valve seat is annular and located radially outboard of the inlet passage.

5. The device of claim 1 wherein the engagement portion is formed from softer material than is the valve seat.

6. The device of claim 5 wherein the engagement portion is formed from a polymeric material having a hardness between 50 to 80 on the Shore-A scale.

7. The device of claim 1 wherein the valve seat is annular and planar, and the engagement portion extends axially relative to the valve seat and relative to an axis of the valve seat.

8. The device of claim 1 which also includes a diaphragm carried by the body assembly and defining part of the fuel chamber, wherein the diaphragm has a portion that moves relative to the valve seat and which causes movement of the inlet valve relative to the valve seat.

9. The device of claim 8 which also includes a lever that pivots relative to the valve seat and wherein the valve head is carried by the lever and the lever is moved by the diaphragm.

10. The device of claim 9 wherein the lever is coupled to a pin between opposite ends of the lever, and wherein the diaphragm acts upon a portion of the lever that is on one side of the pin and the valve head is carried by the lever on the other side of the pin.

11. The device of claim 4 wherein the valve seat is defined by an insert that is carried by the body assembly and which includes a bore that defines part of the inlet passage.

12. The device of claim 9 wherein the valve head includes a knob that is received in an opening of the lever so that the valve head may tilt and/or slide relative to the lever.

13. The device of claim 2 wherein the lip is formed in a face of the valve head that is opposed to the valve seat, and the lip extends axially to a free end that is spaced from the valve face by between 0.2 mm and 1.2 mm, and the lip has a radial thickness of between 0.4 mm and 1.5 mm.

14. A fuel supply device, comprising:
a main body having a main bore from which fuel is supplied, an inlet passage, a valve seat adjacent to the inlet passage and a fuel chamber communicated with the main bore and with the inlet passage to receive a supply of fuel from the inlet passage;
a cover coupled to the main body;
a diaphragm trapped about its periphery between the main body and the cover to define at least part of the fuel chamber; and
an inlet valve having a valve head with a body and an engagement portion extending outwardly from the body, wherein a portion of the diaphragm moves relative to the valve seat to move the inlet valve relative to the valve seat from an open position in which the engagement portion is spaced from the valve seat and a closed position in which the engagement portion is engaged with the valve seat.

15. The device of claim 14 wherein the engagement portion is defined by an annular lip that is formed in a face of the valve head that is opposed to the valve seat, and the lip extends axially to a free end that is spaced from the valve face by between 0.2 mm and 1.2 mm, and the lip has a radial thickness of between 0.4 mm and 1.5 mm.

16. The device of claim 14 wherein the engagement portion is defined by an annular lip that, when coaxially aligned with the inlet passage, is radially spaced from an edge of the inlet passage by at least 0.5 mm.

17. The device of claim 14 wherein the lever is coupled to a pin between opposite ends of the lever, and wherein the diaphragm acts upon a portion of the lever that is on one side of the pin and the valve head is carried by the lever on the other side of the pin.

18. The device of claim 14 wherein the valve head includes a knob that is received in an opening of the lever so that the valve head may tilt and/or slide relative to the lever.
